(19) United States
(12) Patent Application Publication
(10) Pub. No.: US 2019/0338591 A1
(43) Pub. Date: Nov. 7, 2019

(54) SAFETY DEVICE FOR WALL SURFACE SUCTION-TYPE TRAVEL DEVICE

(71) Applicant: Panasonic Intellectual Property Management Co.,LTD., Osaka (JP)

(72) Inventors: Yoshinari MATSUYAMA, Osaka (JP); Tomohiro SEKIGUCHI, Kanagawa (JP); Shogo MIKAMI, Miyagi (JP); Masaki SHIKANAI, Kanagawa (JP); Takeshi KIKUCHI, Osaka (JP)

(21) Appl. No.: 16/514,170

(22) Filed: Jul. 17, 2019

Related U.S. Application Data
(63) Continuation of application No. PCT/JP2017/044298, filed on Dec. 11, 2017.

(30) Foreign Application Priority Data
Jan. 18, 2017 (JP) 2017-006810

(51) Int. Cl. E06C 1/34

(52) U.S. Cl. CPC E06C 1/34

(57) ABSTRACT

A safety device for a wall surface suction-type travel device that is configured to travel on a wall surface while being suctioned on the wall surface includes an extending member, a support base, and a safety rope. The extending member is configured to be disposed on the wall surface and bendable by self weight. The support base supports the extending member so as to allow the extending member to move in a direction along which the extending member extends. The safety rope connects the extending member with the wall surface suction-type travel device.

### TECHNICAL FIELD

The present disclosure relates to a safety device used for a wall surface suction-type travel device that is capable of traveling on a wall surface while being suctioned on the wall surface.

### BACKGROUND ART

It is known that a wall surface suction-type travel device as is described in PTL 1 is, for example, capable of traveling on a wall surface while being suctioned on the wall surface.

### CITATION LIST

### Patent Literature

PTL 1: Unexamined Japanese Patent Publication No. 2016-97955

### SUMMARY

There is a possibility that a wall surface suction-type travel device will unexpectedly fall from a wall surface while being suctioned on the wall surface due to an external shock (e.g., a gust of wind) or a fault, for example. If the suction-type travel device falls off the wall surface and collides with a floor surface, the suction-type travel device may break by collision. Otherwise, the suction-type travel device that has fallen off the wall surface may result in a collision with something.

The present disclosure provides a safety device used for a wall surface suction-type travel device to prevent the wall surface suction-type travel device that has fallen off a wall surface from breaking by collision and accidentally colliding with something.

A safety device for a wall surface suction-type travel device, according to an aspect of the present disclosure accomplished to solve the problem described above, is a safety device for a wall surface suction-type travel device that is configured to travel on a wall surface while being suctioned on the wall surface. The safety device includes an extending member, a support base, and a safety rope. The extending member is configured to be disposed on the wall surface and bendable by self weight. The support base supports the extending member so as to allow the extending member to move in a direction along which the extending member extends. The safety rope connects the extending member with the wall surface suction-type travel device.

A safety device according to the present disclosure prevents a wall surface suction-type travel device that has fallen off a wall surface from breaking by collision and accidentally colliding with something.

### BRIEF DESCRIPTION OF DRAWINGS

FIG. 1 is a perspective view of a safety device for a wall surface suction-type travel device, according to an exemplary embodiment of the present disclosure.

FIG. 2 is a perspective view showing the safety device that is in use.

FIG. 3 is a block diagram showing a controller and a suction pump.

### DESCRIPTION OF EMBODIMENT

A safety device for a wall surface suction-type travel device, according to an aspect of the present disclosure, is a safety device for a wall surface suction-type travel device that is capable of traveling on a wall surface while being suctioned on the wall surface. The safety device includes an extending member, a support base, and a safety rope. The extending member is disposed on the wall surface and bendable by self weight. The support base supports the extending member so as to allow the extending member to move in a direction along which the extending member extends. The safety rope connects the extending member with the wall surface suction-type travel device.

The safety device having this configuration prevents the wall surface suction-type travel device that has fallen off the wall surface from breaking by collision and accidentally colliding with something.

The extending member is, for example, configured to bend only toward the wall surface. This configuration prevents the extending member from leaning to a side away from the wall surface.

The extending member is a cable carrier, for example.

The safety device, for example, includes a rolling part being disposed on the extending member and being configured to roll on the wall surface. This configuration enables the extending member to be readily drawn out along the wall surface to a predetermined mounting location.

The safety device, for example, includes a draw-out unit that is disposed on the support base to draw the extending member out in the extending direction of the extending member. The draw-out unit allows the extending member to be readily mounted on the wall surface.

The safety device, for example, includes at least one adhering unit being attached to the extending member and being configured to stick to the wall surface. With the adhering unit, the extending member is fastened to the wall surface.

The safety device, for example, includes a controller to control sticking of the adhering unit to the wall surface. This configuration enables the adhering unit to start sticking to the wall surface after the extending member is disposed at a predetermined mounting location on the wall surface. This enables the extending member to be readily drawn out along the wall surface to the predetermined mounting location (as compared with a case in which the extending member is drawn out with the adhering unit sticking to the wall surface).

The adhering unit is, for example, configured to travel on the wall surface while sticking to the wall surface. This configuration enables the adhering unit to move the extending member to a predetermined mounting location on the wall surface.

The support base is mobile, for example. This configuration enables the extending member mounted at a location on the wall surface to readily move to a different location on the wall surface.

An exemplary embodiment will be described in detail below with reference to the drawings as appropriate. However, in some cases, a description more detailed than is necessary is omitted. For example, detailed description of well-known matters and redundant description of structures that are substantially the same may be omitted. This is to avoid unnecessary redundancy in the following description and to facilitate understanding by those skilled in the art.

Note that the inventors provide the accompanying drawings and the description below to help those skilled in the art to fully understand the present disclosure, and do not intend to use the accompanying drawings or the description below to limit the subject matter described in the claims.

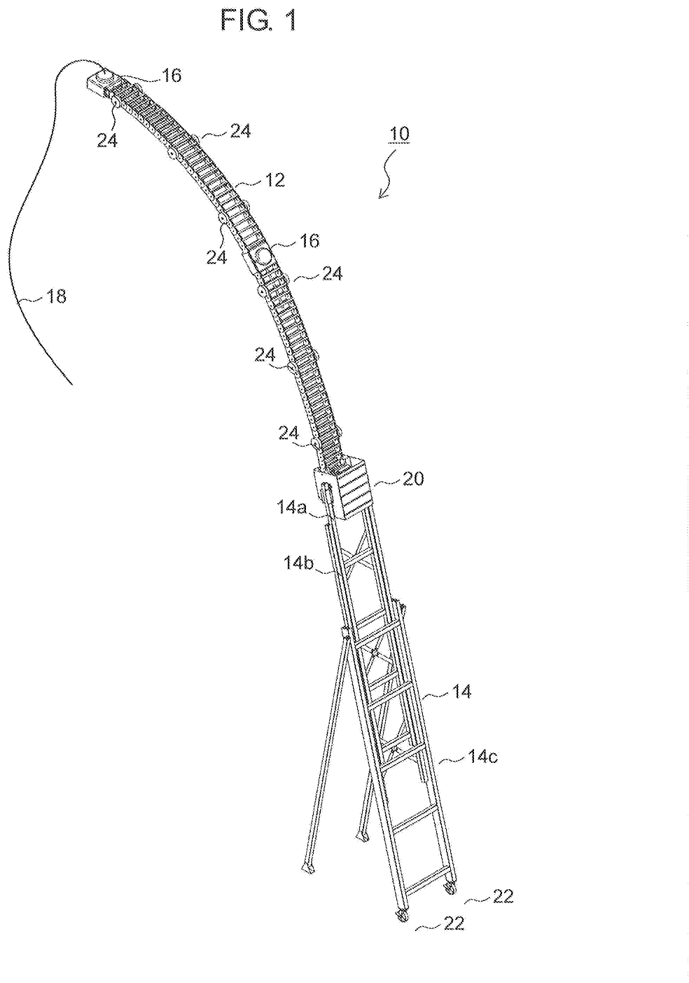

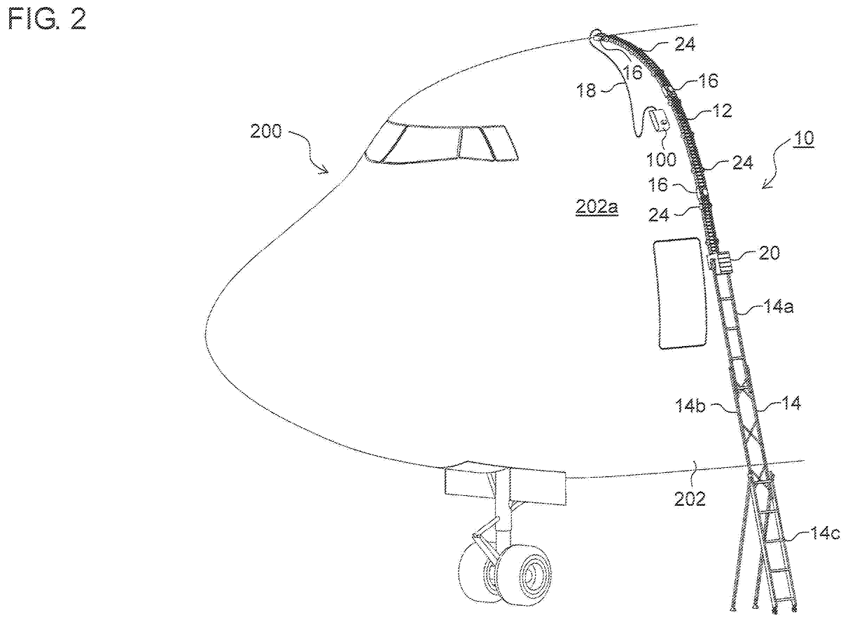

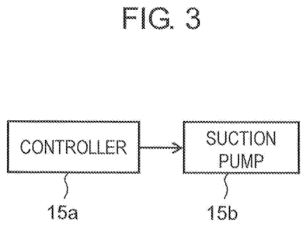

FIG. 1 is a perspective view of a safety device for a wall surface suction-type travel device, according to the exemplary embodiment of the present disclosure. FIG. 2 is a perspective view showing the safety device that is in use. FIG. 3 is a block diagram showing a controller and a suction pump.

First, the wall surface suction-type travel device will be described.

As shown in FIG. 2, wall surface suction-type travel device 100 is configured to travel on a wall surface and an overhung surface such as a ceiling surface while being suctioned on any of these surfaces to avoid falling off these surfaces. Wall surface suction-type travel device 100, for example, sticks to a wall surface by being suctioned on the wall surface. Alternatively, wall surface suction-type travel device 100, for example, sticks to a wall surface by electrostatic attraction, magnetism, or other force. A rolling part (e.g., a crawler or a wheel) of wall surface suction-type travel device 100 rolls on a wall surface while the suction-type travel device is suctioned and wall surface suction-type travel device 100 thereby travels on the wall surface. FIG. 2 shows wall surface suction-type travel device 100 traveling on wall surface 202a (an external surface) of fuselage 202 of aircraft 200 while being suctioned on the wall surface.

An adhering function is not essential for a wall surface suction-type travel device to which the safety device according to the exemplary embodiment of the present disclosure is applicable, with proviso that a factor of the wall surface suction-type travel device, such as self weight or friction with a wall surface, enables the suction-type travel device to travel on the wall surface without falling off (as long as the suction-type travel device travels on a wall surface or other surfaces with a slight tilt angle instead of a vertical wall surface, for example). For instance, the adhering function is not essential for a wall surface suction-type travel device if the wall surface suction-type travel device travels on an apex of fuselage 200 or an upper surface of a wing of aircraft 200 shown in FIG. 2.

There is a possibility that wall surface suction-type travel device 100 thus configured will unexpectedly fall from a wall surface while being suctioned on the wall surface due to an external shock (e.g., a gust of wind) or a fault, for example. If wall surface suction-type travel device 100 falls off the wall surface and collides with a floor surface, the suction-type travel device may break by collision. Otherwise, wall surface suction-type travel device 100 that has fallen off the wall surface may result in a collision with something.

Safety device 10, as shown in FIGS. 1 and 2, according to the present exemplary embodiment is provided to prevent such wall surface suction-type travel device 100 from breaking by collision and accidentally colliding with something.

As shown in FIGS. 1 and 2, safety device 10 includes extending member 12, support base 14 to support extending member 12, at least one adhering unit 16 attached to extending member 12, and safety rope 18 connected to wall surface suction-type travel device 100.

Extending member 12 of safety device 10 is a component that is bendable by self weight. In this exemplary embodiment, extending member 12 is a cable carrier configured to bend only toward wall surface 202a. Because of bendable by self weight, extending member 12 is, as shown in FIG. 2, permitted to be mounted on wall surface 202a along curved wall surface 202a. The extending member is bendable only toward wall surface 202a, and this configuration prevents extending member 12 from leaning to a side away from wall surface 202a. Extending member 12 may be a component other than the cable carrier. For instance, extending member 12 may be composed of strips of plates arranged in a column in which the plates adjacent to each other are coupled together through hinges.

As shown in FIG. 2, support base 14 of safety device 10 is designed to support extending member 12 mounted along wall surface 202a and is installed near wall surface 202a such as on a floor surface. Support base 14 supports extending member 12 so as to allow extending member 12 to move in a direction along which extending member 12 extends. This configuration, if support base 14 is properly installed and extending member 12 is drawn out in the extending direction, allows extending member 12 to move on and along wall surface 202a to a predetermined mounting location.

In this exemplary embodiment, support base 14 is adjustable in height. Support base 14 includes head 14a to support extending member 12, intermediate part 14b to support head 14a such that the head is slidable in a height direction, and pedestal 14c to support intermediate part 14b such that the intermediate part is slidable in the height direction.

In this exemplary embodiment, support base 14 is equipped with draw-out unit 20 to draw extending member 12 out in the extending direction. Draw-out unit 20, for example, includes a pair of rollers designed to rotate while clamping extending member 12 therebetween and a motor to rotate the rollers. Draw-out unit 20 allows extending member 12 to be readily mounted on wall surface 202a. Draw-out unit 20 may be omitted if extending member 12 is lightweight (in other words, if extending member 12 can be drawn out along wall surface 202a by human power).

In this exemplary embodiment, support base 14 is mobile. Hence, support base 14 has casters 22. Support base 14 is allowed to move and extending member 12 mounted at a location on wall surface 202a is thereby able to slide to another location on wall surface 202a. This configuration enables extending member 12 to move to a different location on wall surface 202a in a short period of time and readily as compared with a case in which extending member 12 is withdrawn from wall surface 202a to support base 14, support base 14 is moved, and extending member 12 is mounted again onto wall surface 202a from moved support base 14.

Further, in this exemplary embodiment, extending member 12 is provided with a plurality of rolling parts 24 designed to roll on wall surface 202a in order to enable extending member 12 drawn out from support base 14 to readily move along wall surface 202a to a predetermined mounting location. In this exemplary embodiment, rolling parts 24 are wheels. Rolling parts 24 may be, for example, rollers or spheres other than wheels.

Adhering unit 16 of safety device 10 is a device used to fasten extending member 12 to wall surface 202a and is formed of a suction device that, for example, sticks to wall surface 202a by being suctioned on the wall surface. In this exemplary embodiment, as shown in FIG. 2, one adhering unit 16 is disposed at a top of extending member 12. Extending member 12 mounted at a predetermined location on wall surface 202a is fastened to the location with adhering unit 16. Adhering unit 16 may stick to wall surface 202a by electrostatic attraction, magnetism, or other force, for example.

In this exemplary embodiment, adhering unit 16 is designed to maintain sticking to or stop sticking to wall surface 202a. For instance, if adhering unit 16 is a suction device, safety device 10, as shown in FIG. 3, includes suction pump 15b and controller 15a to control suction pump 15b. Support base 14 is provided with suction pump 15b and controller 15a. Suction pump 15b is controlled by controller 15a, and adhering unit 16 thereby maintains sticking to or stops sticking to wall surface 202a. In this exemplary embodiment, an air hose used to supply negative pressure from suction pump 15b to adhering unit 16 is held by extending member 12 acting as a cable carrier. This configuration enables adhering unit 16 to start sticking to wall surface 202a after extending member 12 is disposed at a predetermined mounting location on wall surface 202a. This enables extending member 12 to be readily drawn out as compared with a case in which extending member 12 is drawn out along wall surface 202a with adhering unit 16 sticking to wall surface 202a. Control of sticking performed by adhering unit 16 is not limited to control of sticking ON/OFF. Control of sticking performed by adhering unit 16 may be control of sticking force. If extending member 12 is provided with a plurality of adhering units 16, different ways of control of sticking may be used to control adhering units 16.

As shown in FIG. 2, safety rope 18 of safety device 10 is connected to wall surface suction-type travel device 100. In this exemplary embodiment, safety rope 18 connects extending member 12 with wall surface suction-type travel device 100 through adhering unit 16 attached to the top of extending member 12. Safety rope 18 may be directly fastened to extending member 12.

In response to an unexpected fall of wall surface suction-type travel device 100 from wall surface 202a, falling wall surface suction-type travel device 100 is suspended by safety rope 18. In other words, extending member 12 fastened to wall surface 202a with adhering unit 16 serves to suspend wall surface suction-type travel device 100 that has fallen off wall surface 202a by safety rope 18. This configuration prevents wall surface suction-type travel device 100 from colliding with a floor surface or prevents the occurrence of a collision between falling wall surface suction-type travel device 100 and something.

A length of safety rope 18 between safety device 10 and wall surface suction-type travel device 100 may be made adjustable to expand a range of travel of wall surface suction-type travel device 100 on wall surface 202a. For instance, safety rope 18 is wound around a spool that is disposed on support base 14 and passes through inside the cable carrier (extending member 12) from the spool, reaching the top of the cable carrier and extending from the top to wall surface suction-type travel device 100. The spool is rotated and the length of safety rope 18 between safety device 10 and wall surface suction-type travel device 100 is thereby adjusted.

Safety rope 18 may be provided with a cable for supplying power to or a cable for sending control signals to wall surface suction-type travel device 100. If wall surface suction-type travel device 100 is suctioned on wall surface 202a, safety rope 18 may be provided with an air hose for supplying negative pressure to wall surface suction-type travel device 100. Safety rope 18 may be a cable for electric power or signals.

The safety device according to the present exemplary embodiment described above prevents wall surface suction-type travel device 100 that has fallen off a wall surface from breaking by collision and accidentally colliding with something.

Moreover, the safety device readily prevents wall surface suction-type travel device 100 that has fallen off a wall surface from breaking by collision and accidentally colliding with something. Specifically, safety device 10 for wall surface suction-type travel device 100 is similar in functionality to a piton that is used in climbing a cliff. However, unlike a piton that a person climbs a wall surface with and that is hammered into the wall surface, safety device 10 allows safety rope 18 connected to wall surface suction-type travel device 100 to be fastened to an upper location on a wall surface from a ground surface (a floor surface) on which support base 14 is installed. As shown in FIG. 2, if wall surface suction-type travel device 100 travels on wall surface 202a of aircraft 200, safety rope 18 connected to wall surface suction-type travel device 100 can be fastened to the apex of fuselage 202 of aircraft 200 without using a boom lift or something similar.

Exemplary embodiments of the present disclosure are not limited to the exemplary embodiment described above.

In the exemplary embodiment described above, as shown in FIG. 2, one wall surface suction-type travel device 100 is connected with safety device 10 via safety rope 18, for example. Applications of the present disclosure are not limited to this example. A plurality of wall surface suction-type travel devices 100 may be connected with safety device 10 via a plurality of safety ropes 18.

In the exemplary embodiment described above, adhering unit 16 is not equipped with a travel unit. In other words, extending member 12 is drawn out, and adhering unit 16 disposed on extending member 12 thereby travels. However, exemplary embodiments of the present disclosure are not limited to this example. For instance, adhering unit 16 may be designed to travel on a wall surface while sticking to the wall surface. In other words, adhering unit 16 is formed of a wall surface suction-type travel device. Thus, adhering unit 16 may travel on the wall surface to move extending member 12 to a predetermined mounting location on the wall surface.

An adhering unit may be omitted from a safety device, with proviso that a factor of an extending member, such as self weight or friction with a wall surface, enables the extending member to stay at a predetermined mounting location without sliding over the wall surface and that the safety device is capable of suspending a wall surface suction-type travel device by a safety rope without a shift of the extending member in response to a fall of the wall surface suction-type travel device from the wall surface. For instance, if the extending member is mounted on the apex of fuselage 202 or the upper surface of a wing of aircraft 200 shown in FIG. 2, the safety device does not necessarily have to include the adhering unit.

In the exemplary embodiment described above, extending member 12 is a cable carrier configured to bend only toward a wall surface. However, exemplary embodiments of the present disclosure are not limited to this example. If the cable carrier is allowed to be readily drawn out along the wall surface with the adhering unit sticking to the wall surface, extending member 12 may be configured to bend to a side away from the wall surface.

In other words, in a broad sense, a safety device configured for a wall surface suction-type travel device according to the present disclosure is a safety device for a wall surface suction-type travel device that is capable of traveling on a wall surface while being suctioned on the wall surface. The safety device includes an extending member, a support base, and a safety rope. The extending member is disposed on the wall surface and bendable by self weight. The support base supports the extending member so as to allow the extending member to move in a direction along which the extending member extends. The safety rope connects the extending member with the wall surface suction-type travel device.

The exemplary embodiment has been described above as an example of the technique of the present disclosure. For this purpose, the accompanying drawings and the detailed description have been provided. Accordingly, in order to illustrate the above technique, the components described in the accompanying drawings and the detailed description may include not only components that are essential for solving the problem but also components that are not essential for solving the problem. For this reason, it should not be immediately deemed that those unessential components are essential just because those unessential components are described in the accompanying drawings and the detailed description.

Since the above described exemplary embodiment is intended to exemplify the technique according to the present disclosure, various modifications, replacements, additions, and omissions can be made within the scope of the appended claims or of their equivalents.

### INDUSTRIAL APPLICABILITY

The present disclosure is applicable to a device that travels on a wall surface while being suctioned on the wall surface.

### REFERENCE MARKS IN THE DRAWINGS

10: safety device

12: extending member

14: support base

16: adhering unit

18: safety rope

100: wall surface suction-type travel device

202a: wall surface

1. A safety device for a wall surface suction-type travel device that is configured to travel on a wall surface while being suctioned on the wall surface, the safety device comprising:
an extending member configured to be disposed on the wall surface, the extending member being bendable by self weight;
a support base to support the extending member so as to allow the extending member to move in an extending direction of the extending member; and
a safety rope to connect the extending member with the wall surface suction-type travel device.

2. The safety device according to claim 1, wherein the extending member is configured to bend only toward the wall surface.

3. The safety device according to claim 1, wherein the extending member is a cable carrier.

4. The safety device according to claim 1, further comprising a rolling part being disposed on the extending member and being configured to roll on the wall surface.

5. The safety device according to claim 1, further comprising a draw-out unit that is disposed on the support base to draw the extending member out in the extending direction of the extending member.

6. The safety device according to claim 1, further comprising an adhering unit being attached to the extending member and being configured to stick to the wall surface.

7. The safety device according to claim 6, further comprising a controller to control sticking of the adhering unit to the wall surface.

8. The safety device according to claim 6, wherein the adhering unit is configured to travel on the wall surface while sticking to the wall surface.

9. The safety device according to claim 1, wherein the support base is mobile.
